(19) United States
(12) Patent Application Publication
(10) Pub. No.: US 2006/0036966 A1
(43) Pub. Date: Feb. 16, 2006

(54) Method and system for presenting links associated with a requested website

(76) Inventor: Slava Yevdayev, Tel Aviv (IL)

Correspondence Address: BROWDY AND NEIMARK, P.L.L.C.;624 NINTH STREET, NW, SUITE 300, WASHINGTON, DC, 20001-5303, US

(21) Appl. No.: 10/914,150

(22) Filed: Aug. 10, 2004

(51) Int. Cl. G06F 3/00

(52) U.S. Cl. 715/779

(57) ABSTRACT

A dynamic toolbar operates in conjunction with a web server for presenting links associated with a website requested by a web surfer at a client computer. The web server receives a source URL of a source website requested by the web surfer and compiles a directory of URLs of related websites that may be of interest to the web surfer for selecting therefrom a subset of URLs according to their popularity. Data representative of the subset is uploaded to the client computer for displaying by a web browser thereof. The subset of URLs is selected by accessing the directory to determine a category to which the source URL belongs and extracting from the directory respective URLs of related websites of the category. A Popularity Index is determined by an actual count of redirections from the URL of the source website to the respective URLs of the related websites.

### FIELD OF THE INVENTION

The invention relates to a method of dynamically improving the usability and efficiency of Internet searching and browsing, and to a method of organizing and ordering sites in a directory.

### BACKGROUND OF THE INVENTION

Toolbars are a well-known feature of graphical user interfaces in software applications and are used to display features that may be selected by a user simply by clicking on an item in the toolbar. Recently the trend has been to make toolbars dynamic so as to reflect an instantaneous state of a software application, typically based on a user's profile or previous selections. An example of such a dynamic toolbar is described in US 2002/0149623A1 (West et al.) published Oct. 17, 2002 and entitled “State and data driven dynamic menu and toolbar architecture”. An application is provided that has a set of menu/toolbar entities and can be in one of a plurality of application states at any given time. Information indicative of an application state characteristic for each application state of the application is contained in a data file, and each application state characteristic defines a display characteristic of at least one of the set of menu/toolbar entities. The system generates a displayed set of menu/toolbar entities on the graphical user interface based upon the application state characteristic of a current one of the application states of the application.

Search engines, directories and toolbars delivering targeted search results are also known. For example, US 2001/0029527A1 (Goshen) published Oct. 11, 2001 and entitled “Method and system for providing a customized browser network” discloses a method including identifying a Uniform Resource Locator (URL) associated with at least one content provider and a browser, and customizing the browser by modifying at least one portion of the browser based upon the URL.

Active components known as “morphs” are used to change the web browser's look and functionality according to the web site being viewed. For example, morphs are provided for dynamically changing function buttons displayed on the toolbar. Morphs may be responsive to a user profile listed in the browser server's database and may be customized to themes so as to display theme-related tool buttons. Morphs may likewise be customized according to web page or website so as to allow the browser to change according to a currently displayed web page or a currently accessed website. In use, a user enters a URL request. A client module relays the URL request and a user ID of the user to the browser server, which analyzes the URL request and the user ID and creates morph data (i.e., browser modification information) based upon the user preferences and the content provider (i.e., website) data stored in a user database and site database. The browser server then sends the morph data to the client. The browser modification may comprise a dynamic toolbar having one or more pull-down menus, which reflect all or part of a site map and facilitate user navigation.

Likewise, US 2002/0057299A1 (Oren et al.) published May 16, 2002 and entitled “System and method for the dynamic improvement of internet browser navigability” discloses a method and system for dynamically updating a web browser's toolbar. The HotbarToolbar comprises a plurality of categorized or rated links, which may be organized under customized, newly and dynamically added toolbar buttons known as hotbuttons. The name and/or content of the hotbuttons may change dynamically in accordance with various factors including, but not limited to, changes in URL. Thus, the customized browser might associate the URL to a pre-cataloged directory which defines related hotbutton topics. Likewise, the toolbar software may analyze the content of the page displayed, and, upon finding certain keywords, identify hotbuttons relevant to those keywords. Alternatively, or additionally, the customized browser can analyze the IP address underlying the URL to which the customized browser has been directed, and infer therefrom other information which it can then use to assign the relevant topics to the hotbuttons.

US 20030050834A1 (Caplan) published Mar. 13, 2003 and entitled “System and method for dynamic customizable interactive portal active during select computer time” discloses a dynamic transactional broadcasting portal display screen application activated during idle time instead of a conventional screensaver. Client software delivers to the screen a dynamic portal, comprising any combinations of video, stills and audio or other digital content. A dynamic toolbar is displayed and is customized for each individual screen, thereby making the portal complete as each screen's toolbar transports the user to multiple predefined websites, all dynamically updated and transformed with each new screen. All movements and decisions made by the user are recorded and distributed over the Internet or other network to a network server, where each user profile is cataloged and a dynamic demographic database is created for sampling, analysis and application functionality enhancement. Content may be filtered according to the user profile and content that conforms to the user profile and whose URLs are stored in a database may be sorted according to a ranking meter so as to allow a playlist to be displayed on the toolbar in ranking order according to a user's profile and preferences.

Google.com, currently the market leader, is a crawler-based search engine that returns results ordered by a combination of keywords and in particular, the number of links connected to the site displayed, regardless of the nature, relevance or use of those links. AskJeeves.com focuses on enabling users to input requests using “natural language” and Yahoo.com, the Internet's oldest directory of websites, uses both a human-edited directory and automated search results to return listings in alphabetical order. The directory is organized into categories and associated sub-categories and the editors sort URLs so as to associate each URL with the most appropriate category and sub-categories. This has the advantage over crawler-based search engines that a directory is pre-sorted and thus is assured to contain only those URLs likely to be of interest to a surfer using the directory. However, the directory neither reflects a site's popularity nor helps the user identify the most suitable content.

Toolbars that plug directly into a computer's web browser such as those supplied by Yahoo! and Google allow users to make their searches while surfing other sites, but the results are still delivered on their own sites, interrupting the user's surfing experience.

Toolbars are also known such as those provided by UCmore, which are easily accessible and downloadable over the Internet and permit there to be associated with a web browser a toolbar that is dynamically updated in response to a search entered by a web surfer using any available search engine, such as Google. Thus, by way of example, a web surfer enters one or more keywords into the search box of a primary search engine, such as Google. Google performs its search and displays a list of URLs in the normal way. At the same time, UCmore analyzes the keywords to determine associated sub-categories to which they belong and which may accelerate the search by enabling the web surfer to click on a desired sub-category so as to reveal URLs that more closely match his or her search strategy. The associated sub-categories are displayed dynamically as clickable buttons in the toolbar. Selecting one of the sub-categories by clicking on the toolbar button causes there to be displayed a pull down menu containing a number of URLs that relate to the selected sub-category. Thus, if the web surfer enters the keyword “Gift”, the toolbar may be dynamically updated to display selectable sub-categories such as “Gift Registry”, “Personalized”, “Gift Baskets”, “Stationery” and so on. Clicking on “Personalized” opens a pull down menu showing yet further sub-categories such as “Promotional Products”, “Personal Greetings”, “Box Your Years”, “Personal Creations”, “Celebration Wines” and so on. On clicking on one of these sub-categories, associated URLs are displayed.

The advantage of such an approach over Google is that it provides finer control over the manner in which search results, i.e. URLs, are displayed for selection. In Google, normally ten matching URLs are displayed at a time and scrolling options are provided to skip forwards and backwards. If none of the matching URLs showed in any given display is of interest, the web surfer must either display more results matching the current search or must refine his or her search strategy. As opposed to this, UCmore associates a category with the keywords entered by the user and displays associated sub-categories that help the user refine his search without having to conceive of a better keyword search as would be necessary with Google and similar search engines. On the other hand, UCmore requires at least two user selections in addition to entering a keyword into the primary search engine since the UCmore toolbar does not display URLs for selection but only associated sub-categories, one of which must be selected before matching URLs are displayed.

It thus emerges that dynamic toolbars associated with directories which include software buttons that are dynamically updated according to a user profile or to URLs entered by the user are known. Specifically, such dynamic toolbars may display different buttons according to a selected theme or website or keyword. However, the prior art appears to make no suggestion to provide a dynamic toolbar that is used as part of a directory and that displays different URLs—as opposed to mere sub-categories—that are dynamically updated according to a selected website or keyword and may be selected directly from the toolbar by a single click.

### SUMMARY OF THE INVENTION

It is therefore an object of the present invention to provide a dynamic toolbar that is used as part of a directory and that displays different URLs—as opposed to mere sub-categories—that are dynamically updated according to a selected website or keyword and that may be selected directly from the toolbar by a single click.

This object is realized in accordance with a first aspect of the invention by a method for presenting links associated with a website requested by a web surfer at a client computer, said method comprising:

receiving a URL of a source website requested by the web surfer;

compiling a directory of URLs of related websites that may be of interest to the web surfer and selecting therefrom a subset of URLs according to their popularity; and

uploading to the client computer data representative of said subset for displaying by a web browser of the client computer.

In accordance with a second aspect of the invention there is provided a method for compiling a database of URLs for facilitating searching, said method comprising:

defining a number of categories to which all URLs in said database are uniquely associated;

for each URL in the database accumulating a respective ongoing count during a specified time period each time a web surfer clicks on said URL from a source website so as to redirect from the source website to a target website corresponding to said URL;

computing from said respective ongoing counts a respective Popularity Index indicative of a probability that a web surfer will redirect from a source URL to said target website;

indexing each URL in the database in accordance with the respective category; and

storing in the database the respective Popularity Index in association with each URL.

Thus, the dynamic toolbar according to the invention makes finding specific content easier for Internet users by delivering automatically results that have proven to be of interest to users. Such a dynamic toolbar is independent of any proprietary search engine and enables searches to be conducted without surfing to a proprietary search engine, and continues to offer further recommendations after a link has been selected.

Users can download the toolbar for use in conjunction with their current web browser or can download a new browser that is pre-adapted for use with the toolbar and possibly incorporating other features. When the user reaches a site, the toolbar locates that site's URL in a corresponding category and displays a number of links to other sites listed in the same category. Related category headings with links to further sites are also displayed in a drop-down menu.

The choice of links displayed is based on an actual count of redirections from the URL of the source website to the respective URLs of related websites. Thus, each time a surfer at the source website clicks on a link to a related website, a cumulative count associated with the URL of the selected related website is incremented and stored. This cumulative count is used as a Popularity Index that serves as a measure of each related website's popularity and only a subset of the most popular websites are displayed for direct selection on the dynamic toolbar.

Users may also enter search terms directly into the toolbar search window. Results drawn from the toolbar directory are displayed along the toolbar. Results are also displayed along the toolbar when searches are conducted using a search engine.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic diagram showing a hierarchy of a source website and related target websites;

FIG. 2 is a detail of the hierarchy depicted in FIG. 1 showing calculation of a Popularity Index indicating the popularity of each related target website shown in FIG. 1;

FIG. 3 is a flow chart showing the principal actions undertaken in conjunction with a dynamic toolbar for displaying URLs based on the popularity of related target websites in accordance with a first embodiment of the invention;

FIG. 4 is a flow chart showing the principal actions undertaken in conjunction with a dynamic toolbar for displaying URLs based on the popularity of related target websites in accordance with a second embodiment of the invention;

FIG. 5 is a flow chart showing the principal actions undertaken in conjunction with a dynamic toolbar for displaying URLs based on the popularity of related target websites in accordance with a variation of the second embodiment of the invention;

FIGS. 6 to 11 are pictorial representations showing different features of a dynamic toolbar according to the invention with a drop down menu displaying selected URLs;

FIG. 12 is a block diagram showing functionally a web server that is adapted to operate in conjunction with a dynamic toolbar according to the invention;

FIG. 13 is a block diagram showing functionally a web browser that is adapted to operate in conjunction with a dynamic toolbar according to the invention; and

FIG. 14 is a block diagram showing functionally a database compiler that is adapted to operate in conjunction with the web server shown in FIG. 12.

### DESCRIPTION OF THE EXEMPLARY EMBODIMENTS

By way of general introduction, users reach Internet sites either by entering the site's URL directly into their browser or by clicking a link that leads from one site to the next. The number of links leading to a site is used by some search engines as an indicator of that site's popularity. A more accurate way to measure both a site's popularity and its relationship to a particular field of interest, however, is to note the number of users who actually click the links on a site whose content is known. If a large number of people click from a dating site to an online relationship magazine for example, it is likely that the magazine's content is of genuine interest to users of dating sites. The invention provides a dynamic toolbar that collects this information and uses it to determine the rankings of sites within directory categories and to make accurate suggestions for further surfing.

FIG. 1 shows a hierarchy of a source website and related target websites. Thus, the root site is the home page, which may be a portal listing a number of search categories such as Travel, Work, News and Entertainment. Each of these categories has sub-categories. To this end, a category that is higher up in the hierarchy and points to a sub-category lower down in the hierarchy will be referred to a source website or source URL and the sub-category to which it points will be referred to a target website or target URL. Thus, “Entertainment” is a main category with respect to “Movies”, “Music”, “Games” and “Relationships”, which list target websites that may be reached from the “Entertainment” source website. The “Relationships” category may display links to target websites “DatingNow.com” and “Match.com” and may also display links to sub-categories “Religious Dating”, “Dating Magazines” and “Dating Directories”.

Sub-categories or target websites may be common to more than source website or URL. For example, although “movies” and “news” are shown as sub-categories or target websites of “entertainment”, they may also be sub-categories or target websites of “news” since a recent music concert or movie may also have appeared in the news. On the other hand, an item (i.e. website) relating to a music concert is more likely to be reached from the music source website than from the news source website. Therefore, the Popularity Index of a target website that is common to multiple source websites will vary for different ones of the source websites. This will become clearer from the following description of how the Popularity Index is calculated.

1. Popularity Index

All links displayed on the dynamic toolbar are drawn from an Internet directory. The directory lists sites in a range of categories and sub-categories compiled by a team of human editors. As users surf the Web, the toolbar tracks the clicks taken to travel from one site to the next, counts the number of times users click to reach that site, and assigns each site a score based on the number of clicks they receive and the relative positions of the Source Site and the Target Site in the directory. Sites that receive clicks from other sites listed in the same category or sub-category receive higher scores than those whose Source Sites are listed in different locations.

This score will be referred to as a “Popularity Index” and it determines the site's relative position within a category, ensuring that the most popular sites are always listed first.

2. Source Sites and Target Sites

As explained above with reference to FIG. 1, Source Sites are the sites that display the links clicked by users. Target Sites are the locations the users reach having clicked on those links. A Source Site can be the inside page of a large website as well as a unique URL. For example, www.DatingNow.com, a dating site, might be listed under Relationships—Dating Sites; www.DatingNow.com/magazine/, a directory of www.DatingNow.com site, a relationships magazine, might be listed under Relationships—Magazines; and www.DatingNow.com/affiliates.htm, a page of www.datingnow.com site, might be listed under Business Opportunities—Online—Affiliate Programs.

3. Calculating the Popularity Index

As stated, the toolbar draws its suggested links from a directory containing the names of Internet sites placed in appropriate categories and ordered by relevance and popularity according to a calculation known as a Popularity Index. The Popularity Index is calculated according to the formula:

$${\sum }_{i = 1}^{n} {x}_{i} \cdot {m}_{i}$$

where xi represents a click generated by users passing through a link on site Ai to site B; mi represents the weighting dependent on the two sites' relative proximity in the directory; and n is the total number of clicks received from all users reaching site B.

For example, with further reference to FIG. 1, the main directory is seen to contain four main categories: Travel, Work, News and Entertainment. The Entertainment category includes the sub-categories Movies, Music, Games and Relationships. The Relationship sub-category lists dating sites such as Match.com and DatingNow.com, as well as other subcategories such as Religious Dating, Dating Magazines and Dating Directories etc.

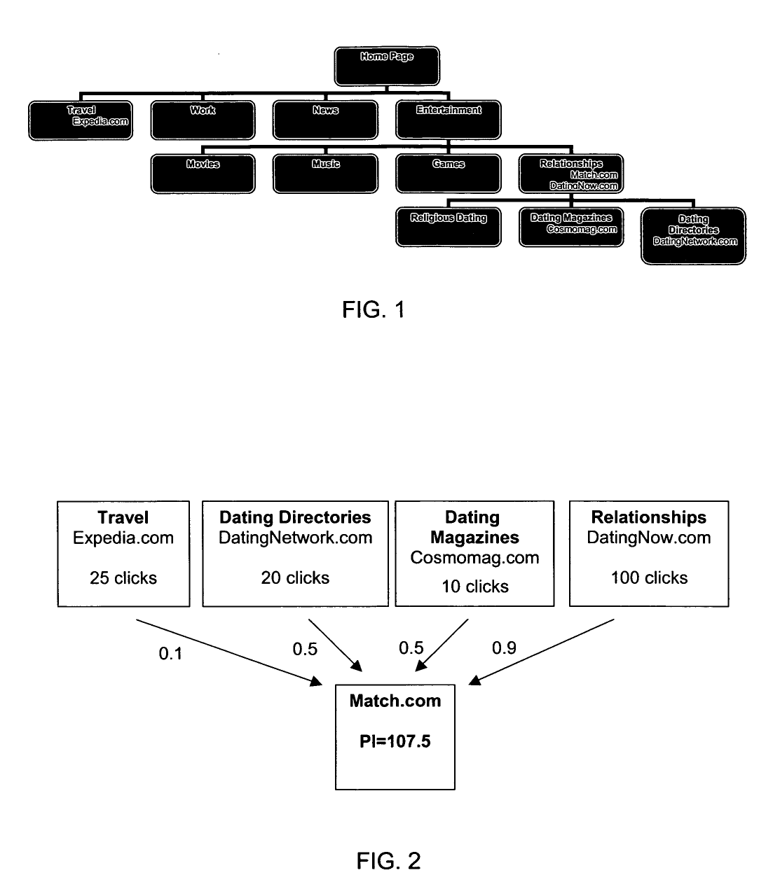

FIG. 2 shows how the Popularity Index is calculated. Match.com, located in Entertainment—Relationships, might receive clicks originating from a number of different sources. Those sources could include DatingNow.com which is listed in the same category, Expedia.com, listed under Travel, and Cosmomag.com and DatingNetwork.com, located in two different but related sub-categories. The weighting given to the clicks depends on the relative proximity of the source site to Match.com. Clicks from Expedia.com might receive a low mi weighting of 0.1 while clicks from DatingNetwork.com and Cosmomag.com could receive a weighting of 0.5. Clicks from DatingNow.com, located in the same category as Match.com could receive a relatively high weighting; for example, 0.9.

If Match.com received a total of 25 clicks from Expedia.com, 20 clicks from DatingNetwork.com, 10 clicks from Cosmomag.com and 100 clicks from DatingNow.com, its Popularity Index would be:
25×0.1+20×0.5+10×0.5+100×0.9=107.5

Thus, the site's position in its category reflects both its popularity and its relevance as determined by the behavior of its users.

4. Determining the Content of Source Sites

When a user reaches a website, the site is identified by its URL and other factors and its position in the Toolbar's directory noted. Its relative distance to the Target Site can then be measured by comparing the two sites' positions in the directory structure when the user clicks a link.

The content of sites that have yet to be listed in the directory will be calculated according to the categories of known Target Sites reached after users have left the unidentified site as well as the categories of the sites from which they have arrived. This enables the toolbar to suggest relevant links for further surfing. For example: a user enters Site A. The toolbar fails to locate Site A in the directory but notices that of 1,000 users who entered the site, 600 clicked on links leading to sites in the Dating category and 200 arrived from sites in the Dating category. The Toolbar then displays a selection of links drawn from that category. Manually entering a URL to reach a site does not affect that site's Popularity Index.

In addition to returning suggested links to sites related to the site currently being viewed, the toolbar also displays a drop-down menu containing a list of related categories, each of which contain further suggested sites. The categories displayed are determined by the categories of the Source Sites from which other users have reached the Target Site. For example, if more people reach sports sites from sports news sites than from health sites then it is more likely that the Sports News category will be displayed. The choice of links listed in each category will be determined by Popularity Index.

Each category is also assigned a database of related keywords. By entering keywords into a search box located on the Toolbar, users can retrieve links drawn from that category and ordered according to Popularity Index.

Search terms entered at search engines also return results on the Toolbar drawn from the directory.

5. How the Popularity Index Changes

The Popularity Index of each site is recalculated periodically by reassessing the statistics in the database to allow for any changes in a site's popularity or content to be reflected in the directory.

FIG. 2 shows the calculation of Match.com's Popularity Index. Match.com has received a total of 25 clicks from Expedia.com, 20 clicks from DatingNetwork.com, 10 clicks from Cosmomag.com and 100 clicks from DatingNow.com. Its Popularity Index is calculated as:
25×0.1+20×0.5+10×0.5+100×0.9=107.5

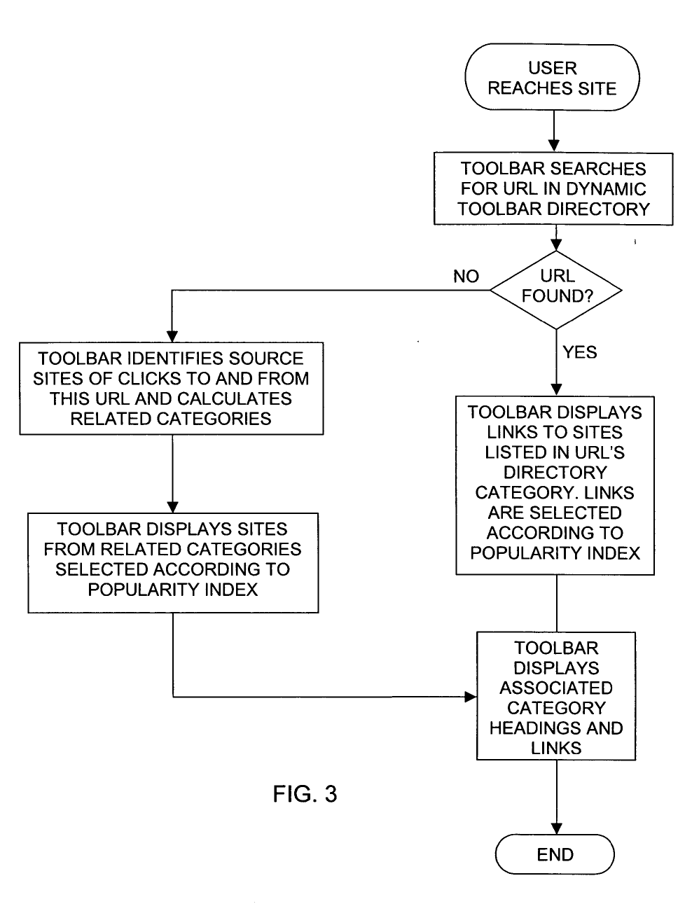

FIG. 3 is a flow chart showing the principal actions undertaken in conjunction with the dynamic toolbar for displaying URLs based on the popularity of related target websites in accordance with a first embodiment of the invention. The URL of the source website is conveyed by the toolbar to a web server, which access a database of URLs in order to establish a respective category. If the URL of the source website is not identified, links based on the categories of other identified sites visited by users surfing to and from the site are displayed. If the URL of the source website is identified, relevant links and categories are shown.

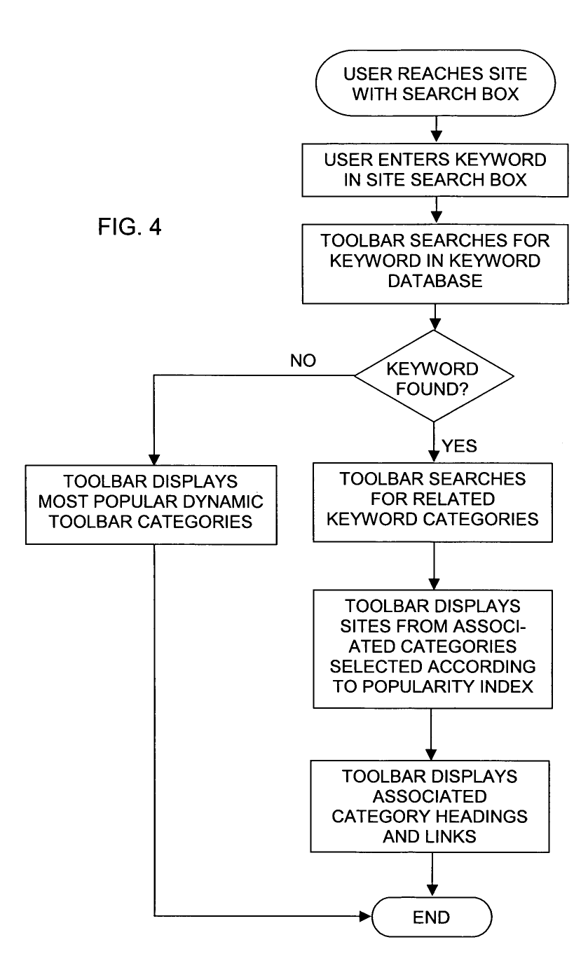

FIG. 4 is a flow chart showing the principal actions undertaken in conjunction with the dynamic toolbar for displaying URLs based on the popularity of related target websites in accordance with a second embodiment of the invention, wherein a user carries out a search at another site. For example, the user may use a proprietary search engine such as Google to locate an initial website and use the toolbar to display associated categories so as to facilitate searching. A keyword is entered by the user into the site's search box and is conveyed by the toolbar to a web server, which accesses a database of keywords in order to establish a respective category. Keywords found in the toolbar's database associated with selected categories and links are displayed according to Popularity Index. If the keyword is not identified, the toolbar displays links to the most popular categories.

On detecting an unknown URL of a source website that is requested by the web surfer and is not in the database, the database is searched for source URLs of source websites that are indexed in the database and from which there have been redirections to the unknown URL. The database is then searched so as to determine target URLs of target websites to which there have been redirections from said source URLs; and the unknown URL is stored in the database in association with a category that is based on respective categories of the target URLs.

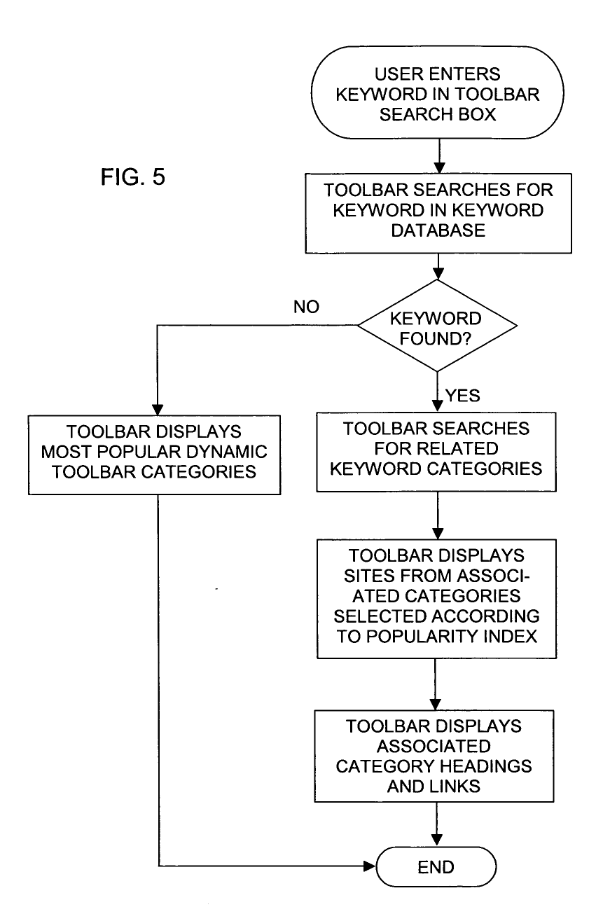

FIG. 5 is a flow chart showing the principal actions undertaken in conjunction with the dynamic toolbar for displaying URLs based on the popularity of related target websites in accordance with a variation of the above-described embodiment. A keyword entered into the toolbar's search box by the user as part of the search is extracted from the search string and conveyed by the toolbar to a web server, which access a database of keywords in order to establish a respective category. Keywords found in the toolbar's database are associated with selected categories and links are displayed according to Popularity Index. If the keyword is not identified, the toolbar displays links to the most popular categories.

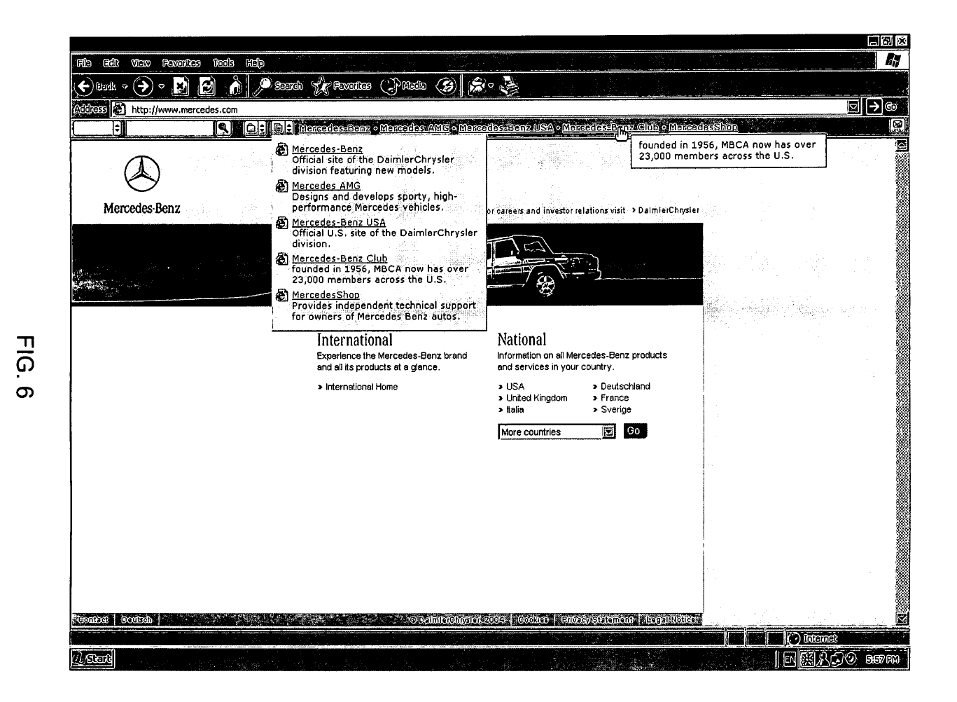

FIGS. 6 to 10 are pictorial representations showing different features of a dynamic toolbar according to the invention with a drop down menu displaying selected URLs.

In FIG. 6, a user has reached the homepage of Mercedes.com. The toolbar has located the site's URL in the directory under Car Manufacturers—Mercedes and selected four links from that category to display. The choice of links has been determined by each site's Popularity Index.

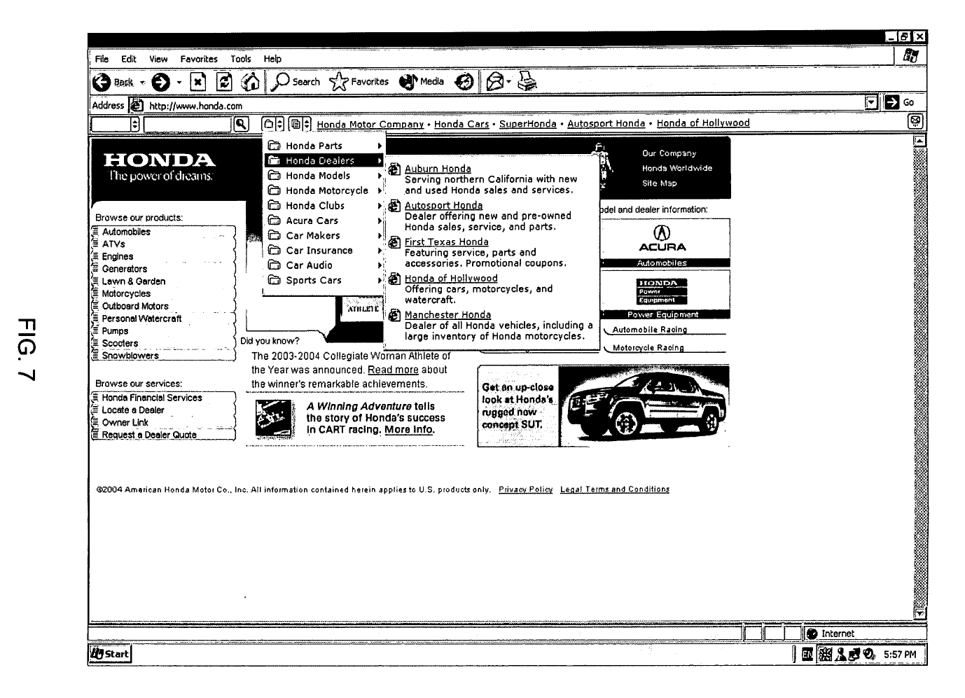

In FIG. 7, the user has reached the homepage of Honda.com. In addition to the choice of links drawn from the directory, the picture also displays the dropdown category menu and a selection of links and descriptions contained in one of those categories. The choice of categories offered in the dropdown menu is determined by a calculation based on the proximity of categories to the category of the target site and their proven popularity for that site's visitors.

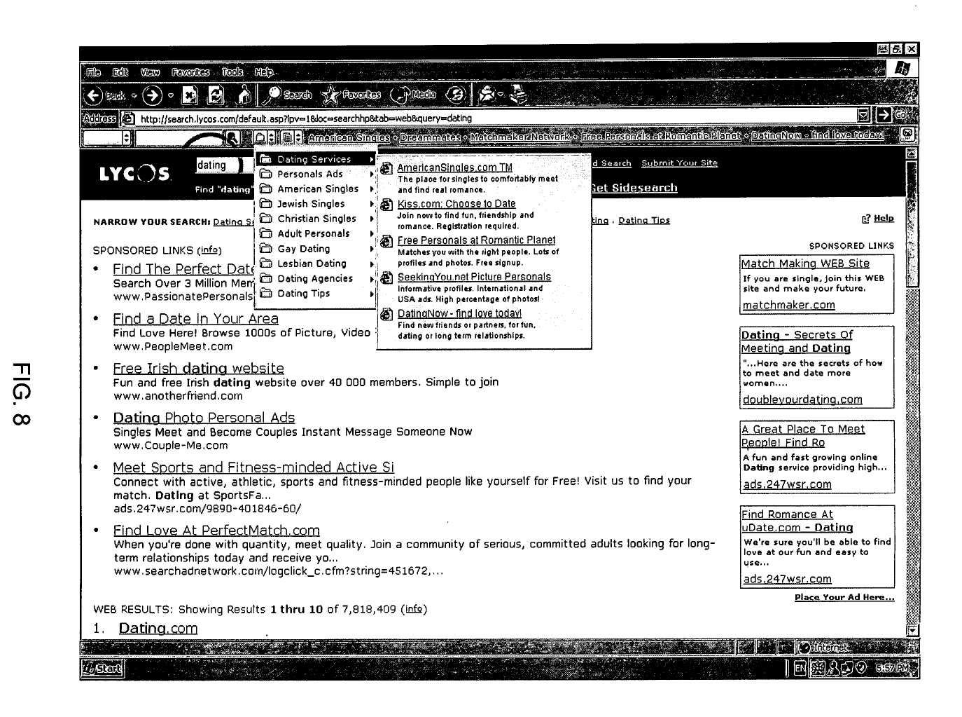

In FIG. 8, the user has conducted a search at Lycos.com, using the keyword “dating”. The toolbar has located the keyword in its database and returned a list of relevant sites based on Popularity index and related categories.

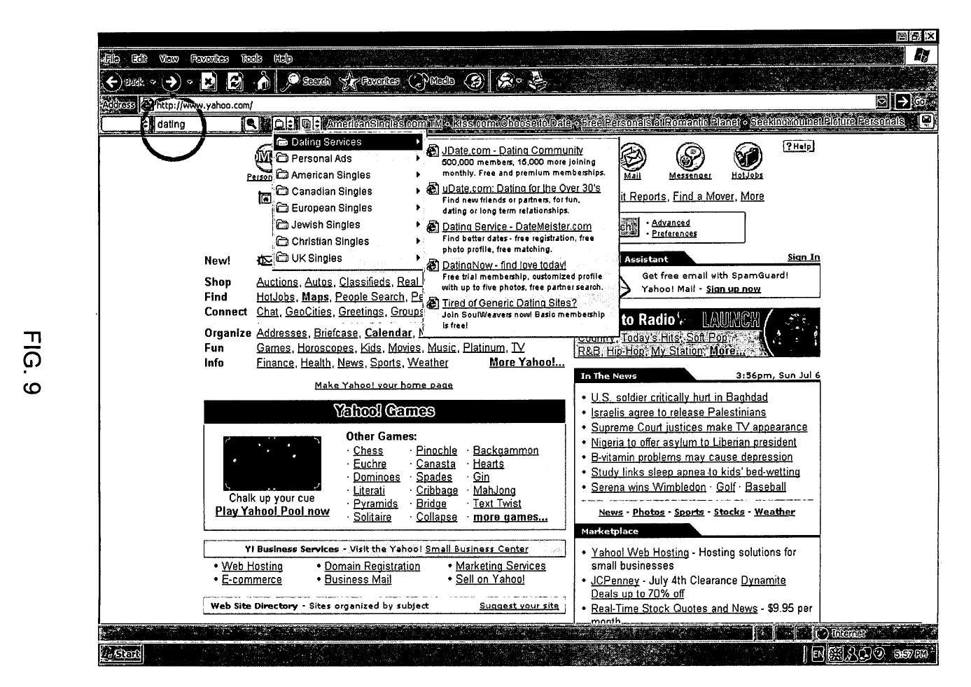

In FIG. 9, the user has entered a keyword directly into the toolbar's search box. The toolbar has located the category related to that keyword in its database and returned a list of relevant sites based on Popularity Index.

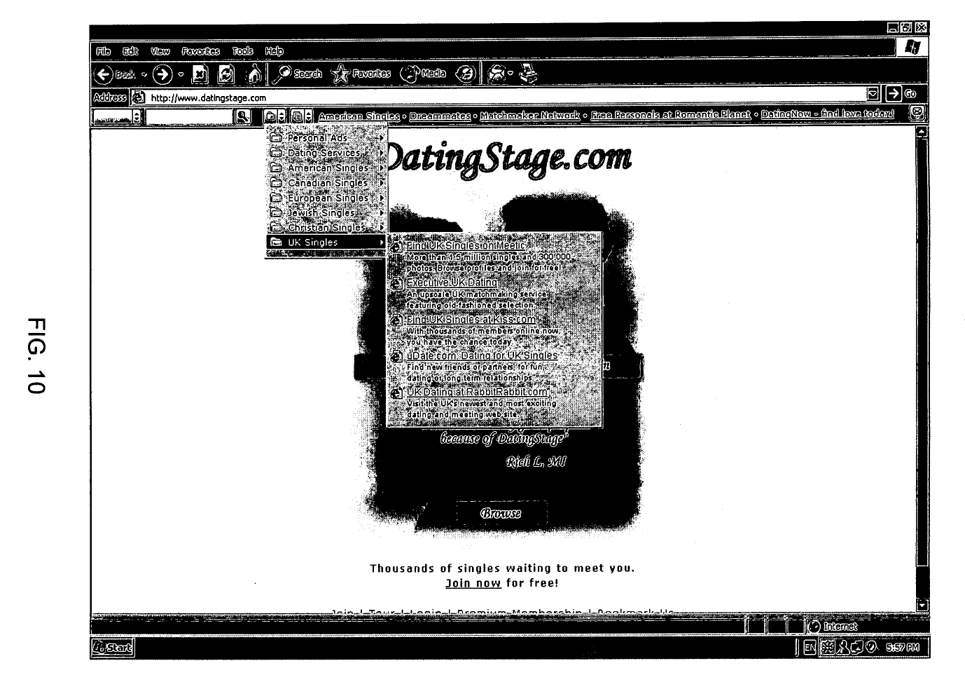

In FIG. 10, the user has reached a site not listed in the toolbar directory. Because the toolbar tracks movement from one site to another, it is able to identify the kinds of sites that other users have reached after leaving the unlisted site. Suggested links are drawn from the category most visited after leaving this Source Site.

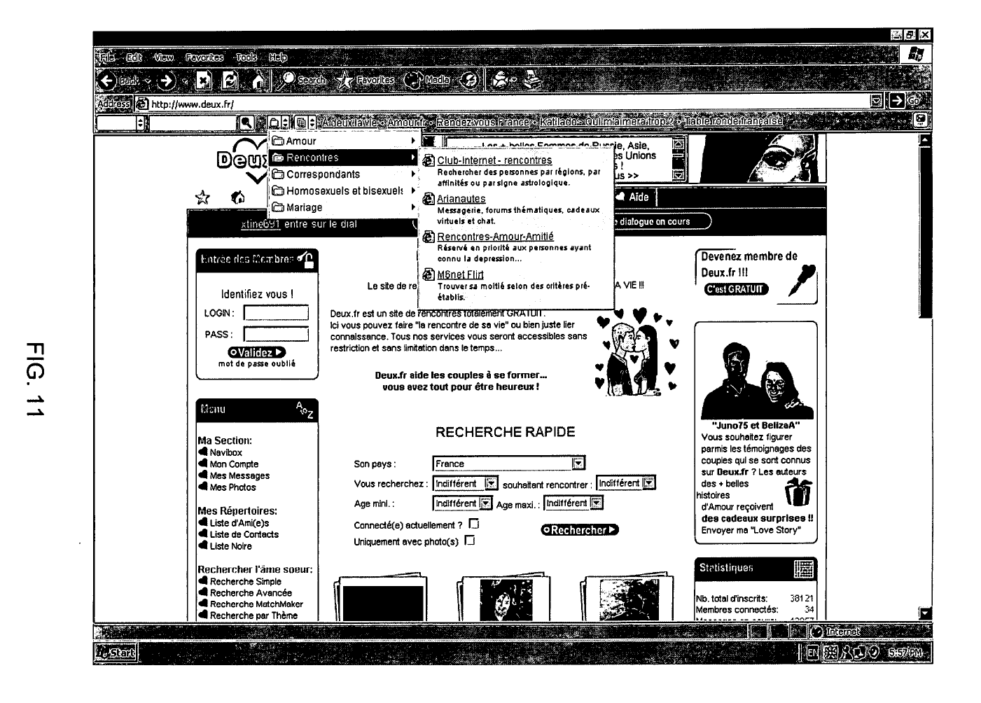

FIG. 11 demonstrates use of the toolbar in other languages. To this end, the database includes language data indicating the language associated with each URL in each category subset. The data representative of each URL in the category subset is formatted in the respective language. Thus, in the example shown in FIG. 11, the language data is in French and the categories and drop-down menus displayed by the toolbar are likewise in French.

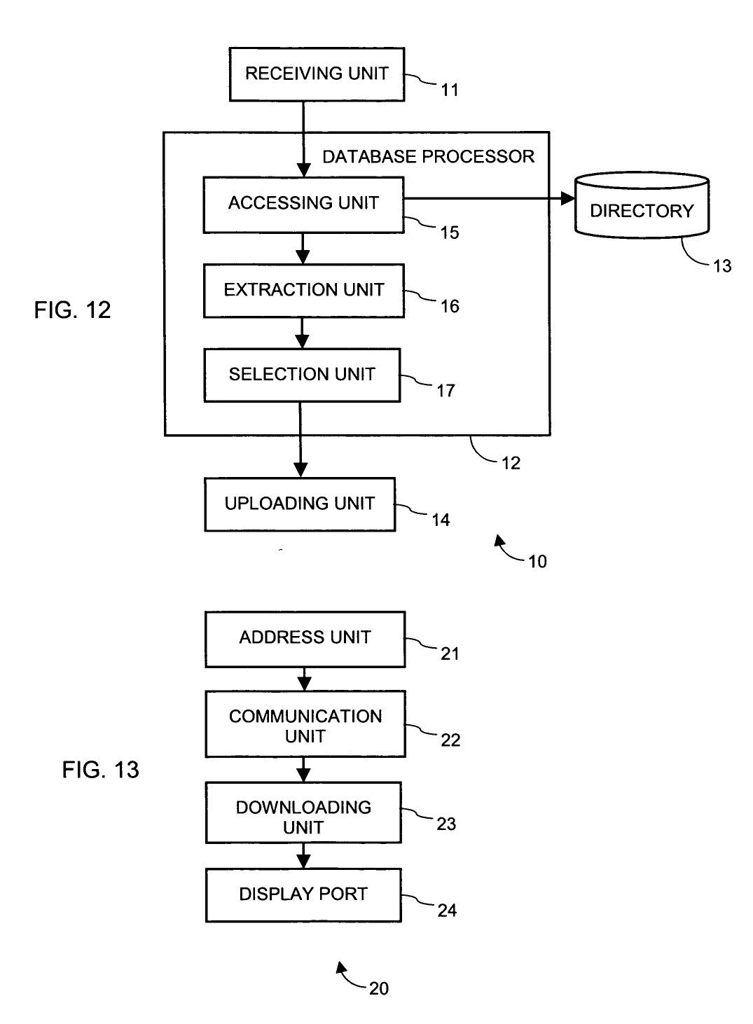

FIG. 12 is a block diagram showing functionally a web server 10 that is adapted to operate in conjunction with a dynamic toolbar according to the invention. The web server 10 comprises a receiving unit 11 for receiving a source URL of a source website requested by the web surfer. A database processor 12 is coupled to the receiving unit 11 for compiling a directory or database 13 of URLs of related websites that may be of interest to the web surfer and selecting therefrom a subset of URLs according to their popularity. An uploading unit 14 is coupled to the database processor 12 for uploading to the client computer data representative of the subset of URLs for displaying by a web browser of the client computer.

The database processor 12 includes an accessing unit 15 for accessing the directory to determine a source category to which the source URL belongs. An extraction unit 16 is coupled to the accessing unit 15 for extracting from the directory respective URLs of related websites of the source category. A selection unit 17 is coupled to the extraction unit 16 for selecting a subset of the respective URLs of related websites of the source category in accordance with a Popularity Index determined by an actual count of redirections from the URL of the source website to the respective URLs of the related websites.

FIG. 13 is a block diagram showing functionally a web browser 20 that is adapted to operate in conjunction with a dynamic toolbar according to the invention. An address unit 21 allows entry of a source URL of a source website and a communication unit 22 is coupled to the address unit 21 for uploading the source URL to the web server 10 (shown in FIG. 12) for accessing the database 13 to determine at least one category to which the source URL belongs and for extracting from the database 13 respective URLs of related websites of each category. A downloading unit 23 is coupled to the communication unit 22 for downloading from the web server 10 data representative of a subset of the respective URLs of related websites of each category in accordance with a Popularity Index determined by an actual count of redirections from the URL of the source website to the respective URLs of the related websites. A display port 24 coupled to the downloading unit 23 permits coupling thereto of a display device (not shown) for displaying the downloaded data.

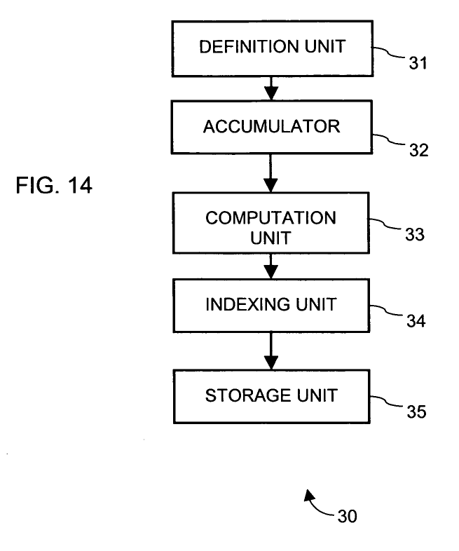

FIG. 14 is a block diagram showing functionally a database compiler 30 that is adapted to operate in conjunction with the web server shown in FIG. 12 for compiling the database 13. The database compiler 30 comprises a definition unit 31 for defining a number of categories to which all URLs in the database are uniquely associated. An accumulator 32 coupled to the definition unit 31 accumulates for each URL in the database a respective ongoing count during a specified time period each time a web surfer clicks on the URL from a source website so as to redirect from the source website to a target website corresponding to the selected URL. A computation unit 33 is coupled to the accumulator 32 for computing from the respective ongoing counts a respective Popularity Index indicative of a probability that a web surfer will redirect from a source URL to the respective target website. An indexing unit 34 coupled to the computation unit 33 indexes each URL in the database 13 in accordance with the respective category, and a storage unit 35 coupled to the indexing unit 34 stores the respective Popularity Index in association with each URL in the database 13.

It will be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method for presenting links associated with a website requested by a web surfer at a client computer, said method comprising:
receiving a URL of a source website requested by the web surfer;
compiling a directory of URLs of related websites that may be of interest to the web surfer and selecting therefrom a subset of URLs according to their popularity; and
uploading to the client computer data representative of said subset for displaying by a web browser of the client computer.

2. The method according to claim 1, wherein selecting a subset of URLs according to their popularity comprises:
accessing the directory to determine a category to which said URL belongs;
extracting from the directory respective URLs of related websites of said category; and
selecting a subset of the respective URLs of related websites of said category in accordance with a Popularity Index determined by an actual count of redirections from the URL of the source website to the respective URLs of said related websites.

3. The method according to claim 1, wherein said data representative of said subset includes respective URLs of said subset.

4. The method according to claim 1, wherein said data representative of said subset includes descriptive information of said subset.

5. The method according to claim 1, including displaying said data representative of said subset in a toolbar used by said web browser.

6. The method according to claim 1, wherein the database includes language data indicating a language associated with each URL in said subset and the data representative of each URL in said subset is formatted in the respective language.

7. The method according to claim 1, further including:
selecting a related subset of related URLs of respective websites of sub-categories related to said category in accordance with a Popularity Index determined by an actual count of redirections from the URL of the source website to the related URLs; and
uploading to the client computer data representative of said related subset for displaying by a web browser of the client computer.

8. The method according to claim 1, further including:
extracting a keyword entered by the web surfer;
accessing a database to determine at least one category to which said keyword belongs;
extracting from the database respective URLs of related websites of said at least one category;
selecting a subset of the respective URLs of related websites of said at least one category in accordance with a Popularity Index determined by an actual count of redirections from the URL of the source website to the respective URLs of said related websites; and
uploading to the client computer data representative of said subset for displaying by a web browser of the client computer.

9. The method according to claim 8, further including:
selecting a related subset of related URLs of respective websites of sub-categories related to said at least one category in accordance with a Popularity Index determined by an actual count of redirections from the URL of the source website to the related URLs; and
uploading to the client computer data representative of said related subset for displaying by a web browser of the client computer.

10. The method according to claim 8, including displaying said data representative of said subset in a toolbar used by said web browser and wherein the keyword is entered into a search box of said toolbar.

11. The method according to claim 9, including displaying said data representative of said subset in a toolbar used by said web browser and wherein the keyword is entered into a search box of said toolbar.

12. The method according to claim 8, including displaying said data representative of said subset in a toolbar used by said web browser and wherein the keyword is entered into a search box of a search engine.

13. The method according to claim 9, including displaying said data representative of said subset in a toolbar used by said web browser and wherein the keyword is entered into a search box of a search engine.

14. The method according to claim 1, wherein on detecting an unknown URL of a source website that is requested by the web surfer and is not in the database there are further included:
searching said database for source URLs of source websites that are indexed in the database and from which there have been redirections to the unknown URL;
searching said database so as to determine target URLs of target websites to which there have been redirections from said source URLs; and
storing the unknown URL in the database in association with a category that is based on respective categories of the target URLs.

15. The method according to claim 1, wherein URLs in said directory are sorted according to their popularity.

16. A method for compiling a database of URLs for facilitating searching, said method comprising:
defining a number of categories to which all URLs in said database are uniquely associated;
for each URL in the database accumulating a respective ongoing count during a specified time period each time a web surfer clicks on said URL from a source website so as to redirect from the source website to a target website corresponding to said URL;
computing from said respective ongoing counts a respective Popularity Index indicative of a probability that a web surfer will redirect from a source URL to said target website;
indexing each URL in the database in accordance with the respective category; and
storing in the database the respective Popularity Index in association with each URL.

17. The method according to claim 16, further including storing in the database language data indicating a language associate with each URL.

18. A method for presenting links associated with a website requested by a web surfer at a client computer, said method comprising:
requesting a URL of a source website;
uploading said URL to a web server for accessing a database to determine at least one category to which said URL belongs and for extracting from the database respective URLs of related websites of said at least one category;
downloading from the web server data representative of a subset of the respective URLs of related websites of said at least one category in accordance with a Popularity Index determined by an actual count of redirections from the URL of the source website to the respective URLs of said related websites; and
displaying said data for use by a web browser of the client computer.

19. The method according to claim 18, wherein said data representative of said subset includes respective URLs of said subset.

20. The method according to claim 18, wherein said data representative of said subset includes descriptive information of said subset.

21. The method according to claim 16, including displaying said data representative of said subset in a toolbar used by said web browser.

22. The method according to claim 21, including selectively displaying said descriptive information when a user points to an associated link displayed in said toolbar.

23. The method according to claim 18, wherein the database includes language data indicating a language associate with each URL in said subset and the data representative of each URL in said subset is formatted in the respective language.

24. The method according to claim 18, further including
downloading from the web server data representative of a related subset of related URLs of respective websites of sub-categories related to said category in accordance with a Popularity Index determined by an actual count of redirections from the URL of the source website to the related URLs; and
displaying said data for use by a web browser of the client computer.

25. The method according to claim 24, including displaying said data representative of said related subset in a toolbar used by said web browser.

26. The method according to claim 25, including displaying the data representative of said related subset in a drop-down menu that is opened by clicking on a related item in the toolbar.

27. The method according to claim 18, wherein the URL of a source website includes a keyword and said subset includes URLs of websites relating to an identical category of said keyword.

28. The method according to claim 27, further including:
downloading from the web server data representative of a related subset of related URLs of respective websites of sub-categories related to said at least one category in accordance with a Popularity Index determined by an actual count of redirections from the URL of the source website to the related URLs; and
displaying said data for use by a web browser of the client computer.

29. The method according to claim 15, wherein URLs in said directory are sorted according to their popularity.

30. A web server for presenting links associated with a website requested by a web surfer at a client computer, said web server comprising:
a receiving unit for receiving a URL of a source website requested by the web surfer;
a database processor coupled to the receiving unit for compiling a directory of URLs of related websites that may be of interest to the web surfer and selecting therefrom a subset of URLs according to their popularity; and
an uploading unit coupled to the database processor for uploading to the client computer data representative of said subset for displaying by a web browser of the client computer.

31. The web server according to claim 30, wherein the database processor comprises:
an accessing unit for accessing the directory to determine a category to which said URL belongs;
an extraction unit coupled to the accessing unit for extracting from the directory respective URLs of related websites of said category; and
a selection unit coupled to the extraction unit for selecting a subset of the respective URLs of related websites of said category in accordance with a Popularity Index determined by an actual count of redirections from the URL of the source website to the respective URLs of said related websites.

32. A database compiler for compiling a database of URLs for facilitating searching, said web server comprising:
a definition unit for defining a number of categories to which all URLs in said database are uniquely associated;
an accumulator coupled to the definition unit for accumulating for each URL in the database a respective ongoing count during a specified time period each time a web surfer clicks on said URL from a source website so as to redirect from the source website to a target website corresponding to said URL;
a computation unit coupled to the accumulator for computing from said respective ongoing counts a respective Popularity Index indicative of a probability that a web surfer will redirect from a source URL to said target website;
an indexing unit coupled to the computation unit for indexing each URL in the database in accordance with the respective category; and
a storage unit coupled to the indexing unit for storing in the database the respective Popularity Index in association with each URL.

33. A web browser for presenting links associated with a website requested by a web surfer at a client computer, said web browser comprising:
an address unit for requesting a URL of a source website;
a communication unit coupled to the address unit for uploading said URL to a web server for accessing a database to determine at least one category to which said URL belongs and for extracting from the database respective URLs of related websites of said at least one category;
a downloading unit coupled to the communication unit for downloading from the web server data representative of a subset of the respective URLs of related websites of said at least one category in accordance with a Popularity Index determined by an actual count of redirections from the URL of the source website to the respective URLs of said related websites; and
a display port coupled to the downloading unit for coupling thereto a display device for displaying said data.

34. A program storage device readable by machine, tangibly embodying a program of instructions executable by the machine to perform a method for presenting links associated with a website requested by a web surfer at a client computer, said method comprising:
receiving a URL of a source website requested by the web surfer;
compiling a directory of URLs of related websites that may be of interest to the web surfer and selecting therefrom a subset of URLs according to their popularity; and
uploading to the client computer data representative of said subset for displaying by a web browser of the client computer.

35. A computer program product comprising a computer useable medium having computer readable program code embodied therein for presenting links associated with a website requested by a web surfer at a client computer, said computer program product comprising:
computer readable program code for causing the computer to receive a URL of a source website requested by the web surfer;
computer readable program code for causing the computer to compile a directory of URLs of related websites that may be of interest to the web surfer and selecting therefrom a subset of URLs according to their popularity; and
computer readable program code for causing the computer to upload to the client computer data representative of said subset for displaying by a web browser of the client computer.

36. A program storage device readable by machine, tangibly embodying a program of instructions executable by the machine to perform a method for compiling a database of URLs for facilitating searching, said method comprising:
defining a number of categories to which all URLs in said database are uniquely associated;
for each URL in the database accumulating a respective ongoing count during a specified time period each time a web surfer clicks on said URL from a source website so as to redirect from the source website to a target website corresponding to said URL;
computing from said respective ongoing counts a respective Popularity Index indicative of a probability that a web surfer will redirect from a source URL to said target website;
indexing each URL in the database in accordance with the respective category; and
storing in the database the respective Popularity Index in association with each URL.

37. A computer program product comprising a computer useable medium having computer readable program code embodied therein for compiling a database of URLs for facilitating searching, said computer program product comprising:
computer readable program code for causing the computer to define a number of categories to which all URLs in said database are uniquely associated;
computer readable program code for causing the computer to for each URL in the database accumulating a respective ongoing count during a specified time period each time a web surfer clicks on said URL from a source website so as to redirect from the source website to a target website corresponding to said URL;
computer readable program code for causing the computer to compute from said respective ongoing counts a respective Popularity Index indicative of a probability that a web surfer will redirect from a source URL to said target website;
computer readable program code for causing the computer to index each URL in the database in accordance with the respective category; and
computer readable program code for causing the computer to store in the database the respective Popularity Index in association with each URL.

38. A program storage device readable by machine, tangibly embodying a program of instructions executable by the machine to perform a method for presenting links associated with a website requested by a web surfer at a client computer, said method comprising:
requesting a URL of a source website;
uploading said URL to a web server for accessing a database to determine at least one category to which said URL belongs and for extracting from the database respective URLs of related websites of said at least one category;
downloading from the web server data representative of a subset of the respective URLs of related websites of said at least one category in accordance with a Popularity Index determined by an actual count of redirections from the URL of the source website to the respective URLs of said related websites; and
displaying said data.

39. A computer program product comprising a computer useable medium having computer readable program code embodied therein for presenting links associated with a website requested by a web surfer at a client computer, said computer program product comprising:
computer readable program code for causing the computer to request a URL of a source website;
computer readable program code for causing the computer to upload said URL to a web server for accessing a database to determine at least one category to which said URL belongs and for extracting from the database respective URLs of related websites of said at least one category;
computer readable program code for causing the computer to download from the web server data representative of a subset of the respective URLs of related websites of said at least one category in accordance with a Popularity Index determined by an actual count of redirections from the URL of the source website to the respective URLs of said related websites; and
computer readable program code for causing the computer to display said data.
